(19) United States
(12) Patent Application Publication
(10) Pub. No.: US 2007/0102386 A1
(43) Pub. Date: May 10, 2007

(54) NESTABLE AND STACKABLE DOCUMENT STORAGE TRAYS

(75) Inventors: Timothy D. Killinger, Plainfield, IL (US); Matthew G. Lerch, Chicago, IL (US); Aaron W. Smith, Plainfield, IL (US); Gilberto Cavada JR., Melrose Park, IL (US); Melanie L. Conklin, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SANFORD, L.P., Freeport, IL (US)

(21) Appl. No.: 11/618,060

(22) Filed: Dec. 29, 2006

Related U.S. Application Data
(63) Continuation of application No. 11/098,060, filed on Apr. 4, 2005.
(60) Provisional application No. 60/559,312, filed on Apr. 2, 2004.
(60) Provisional application No. 60/592,366, filed on Jul. 29, 2004.
(60) Provisional application No. 60/590,146, filed on Jul. 22, 2004.

(51) Int. Cl. A47F 3/14; A47J 47/00

(52) U.S. Cl. 211/126.7

(57) ABSTRACT

Document storage trays are disclosed that may be stacked in at least two different configurations including a “nesting” stack where an upper tray fits within the storage area of a lower tray and, in turn, is also able to receive a tray within its own storage area so that multiple trays can be stacked nested together. The document storage trays may also be stacked in a vertical configuration and the trays include appropriately placed slots, detents, bosses and legs for a stable vertical stacking configuration so that multiple trays may be stacked one on top of another and form a stable structure. At least one embodiment further enables the trays to be stacked in a cascaded form so that front edges of the trays are staggered laterally from the bottom tray to the top tray. At least one embodiment includes a built-in collating function so that each tray is able to receive documents from one of two different and perpendicularly oriented sides.

This is a continuation of U.S. application Ser. No. 11/098,060, filed Apr. 4, 2005, which is related to and claims priority benefit of provisional application Ser. Nos. 60/559,312, filed on Apr. 2, 2004, 60/590,146, filed on Jul. 22, 2004, and 60/592,366 filed on Jul. 29, 2004, and incorporating by reference herein all of the subject matter disclosed in said prior provisional applications

### BACKGROUND

1. Technical Field of the Disclosure

This present disclosure is generally directed to document storage and organizing products, and more particularly to stackable and nestable document storage trays.

2. Description of the Related Art

Organization and storage trays for documents are known in the art. These storage trays are intended either for stand alone use or for being vertically stacked with identical storage trays for multi-level use. However, such trays are often shipped and displayed in individual form or in the in-use stacked condition. Consequently, these known document or storage trays take up a relatively large amount of retail shelf space and also a significant amount of space during shipment.

The consumption of relatively large amounts of retail shelf space by plastic storage trays is problematic, as retail shelf space is extremely valuable and manufacturers compete vigorously for adequate shelf space to display their products. Any inefficient use of retail shelf space can lead to a manufacturer's products not being adequately displayed, as well as a reduction in the number of different products a manufacturer may be allowed to display in a given retail store. Further, because molded plastic document trays are relatively inexpensive items, the use of shelf space to display these items must be efficient.

Further, because the profit margins for these items can be relatively small, a means for packaging these items in a compact manner is important for reducing shipment and handling costs of such low margin products.

Typical document storage trays are not nestable with more than one identical storage tray. To stack a pair of such trays, one tray must be inverted and rotated 180 degrees relative to the other. The two trays can then be rested on top of one another, but no other trays can be nested with these two. Therefore, currently available document storage trays cannot be compactly stacked together in groups of more than two (or a pair).

Often, it is desirable to sell such document storage trays in groups of more than two to provide more than two levels of storage or for use by more than one person. Thus, currently available document storage trays cannot be efficiently displayed, stored or shipped in groups of more than two. Further, if more than two trays are packaged together or shipped together, additional packaging material such as cardboard, Styrofoam, plastic film and the like must be utilized to prevent product damage from relative movement between trays from scuffing or scratching during shipment and handling.

Because of the limitations of currently available document storage trays discussed above, their use is typically limited to a single pair of stacked trays. While some available designs allow more than two trays to be stacked on top of each other, the design of such trays make them expensive to package and ship and inefficient to display in the retail environment.

Further, there is no currently available set of stackable document storage trays that also provide an effective collating function. Collating can be useful for storing different sizes of paper (i.e., 8½×11, A4, 8½×14, 8½×17, etc.) or for storing documents of different types (i.e., incoming mail, outgoing mail, invoices, mail directed towards different people, etc.). Currently available stackable storage tray designs often require the user to work their way down the stack of trays searching for a particular paper size or document. A stackable storage tray system that provides a collating function and that addresses the space and packaging problems discussed above would most likely be well received by consumers and retailers.

### SUMMARY OF THE DISCLOSURE

In satisfaction of the aforenoted needs, stackable document storage trays are disclosed which address one or more of the aforenoted problems. In one embodiment, a plurality of trays may be stacked tightly together in a nested configuration for packaging, shipment, handling and for display in a retail environment. This embodiment also has at least two in-use stacked configurations including a vertical stacked configuration where the trays are stacked vertically one on top of another and a second cascaded configuration where the trays are stacked on top of each other but with each successive tray being displaced laterally from the bottom tray to provide a cascaded or stepped configuration. In this embodiment, the lateral displacement may be alternated to form a stacked forward and backward configuration as well.

Another disclosed embodiment includes a built-in collating function. In this embodiment, each tray includes only two walls with two open areas for receiving documents. A corner post structure is used to separate one receiving area from the other receiving area. The trays may be stacked in a vertical configuration and the user can alternate between one receiving area and the other receiving area upward or downward through the stack of trays. The collating trays can also be nested for shipping, storage, and display for sale.

Other advantages and features of the disclosed embodiments will become apparent upon reading the following detailed description and forthcoming claims, and upon reference to the accompanying drawings.

### BRIEF DESCRIPTION OF THE DRAWINGS

Certain features and advantages of the present invention will become apparent upon reading the following description in conjunction with the drawing figures, wherein:

FIG. 1 is a top perspective view of one example of a document tray constructed in accordance with the teachings of this disclosure.

FIG. 2 is a bottom perspective view of the document tray shown in FIG. 1.

FIG. 3 is a front view of the document tray shown in FIG. 1.

FIG. 4 is a top view of the document tray shown in FIG. 1.

FIG. 5 is a cross section taken along line V-V of the document tray shown in FIG. 1.

FIG. 5A is a close up perspective view of region A of FIG. 1 taken from above and offset from one of the side walls.

FIG. 5B is a second close up perspective view of region A of FIG. 1 taken from below and offset from one of the side walls.

FIG. 6 is a side view of three document trays as shown in FIG. 1 as stacked in a nested configuration for shipment, packaging or retail display.

FIG. 7 is a side view of three document trays as shown in FIG. 1 and stacked in a vertical in-use configuration.

FIG. 8A is a side view of three document trays as shown in FIG. 1 and cascaded in an in-use configuration.

FIG. 8B is a perspective view of an alternative embodiment of a document tray constructed in accordance with the teachings of the disclosure.

FIG. 9 is a perspective view of three document trays of an alternative embodiment and shown in the nested configuration.

FIG. 10 is a top plan view of the three nested trays shown in FIG. 9.

FIG. 11 is a sectional view taken substantially along line XI-XI of FIG. 10.

FIG. 12 is a perspective view of the trays shown in FIGS. 9-11 and stacked in a vertical in-use configuration.

FIG. 13 is a top plan view of the trays stacked vertically as shown in FIG. 12.

FIG. 14 is a sectional view taken substantially along line XIV-XIV of FIG. 13.

FIGS. 15A-15F are, respectively, front perspective, rear perspective, top, bottom, rear, and front views of another example of a document tray constructed in accordance with the teachings of the present invention.

FIGS. 16A-16D are front, side, and perspective views of an in-use stack of two of the document trays shown in FIGS. 15A-15F.

FIGS. 17A-17D are front, side, and perspective views of two document trays of FIGS. 15A-15F in a nested and stacked configuration.

FIGS. 18A-18E are, respectively, front perspective, side, front, top, and alternate front perspective views of another example of a document tray constructed in accordance with the teachings of the present invention.

FIGS. 19A-19D are trays as shown in FIGS. 18A-18E in a stacked and nested configuration.

FIGS. 20A-20D are trays as shown in FIGS. 18A-18E in a stacked configuration.

FIGS. 21A-21D are trays as shown in FIGS. 18A-18E in a stacked and cascading configuration.

It will be understood that the drawings are not to scale and that, in some instances, details which are not necessary for an understanding of the disclosed embodiments or which render other details difficult to perceive, may have been omitted. It should be understood, of course, that this disclosure is not limited to the embodiments specifically illustrated in the drawings.

### DETAILED DESCRIPTION OF THE DISCLOSED EMBODIMENTS

A letter tray or document storage tray device, hereinafter described as a document tray, for storing papers, files, documents, and the like, for storing and organizing such articles in a horizontal orientation is shown and described. The disclosed document trays can be stacked with like or identical storage trays during use in order to provide multiple storage levels. Alternatively, the disclosed trays can nest with one another in an alternative stacked configuration to reduce the amount of retail display shelf space and shipping space that is required of a large number of the document trays. The disclosed document trays can be both stacked and nested with a plurality of like trays so that when packaged and shipped or when on display for sale to consumers, the document trays take up relatively little shelf space and much less space than traditional document trays of similar type. Obviously, shipping costs are also reduced.

In at least one embodiment, the trays may be stacked in a cascaded or staggered orientation so that the forward edge of one tray is horizontally offset from the forward edge of a tray disposed therebelow or, conversely, the forward edge of the bottom tray is horizontally offset from the forward edges of the trays disposed thereabove. In at least one other embodiment, instead of the “cascaded” function described above, the trays can be designed with two open sides arranged at an angle relative to one another, such as at generally right angles or 90° from each other, thereby allowing the user to make controlled or collated stacks of documents. Specifically, proceeding from the bottom or top of a stack of this type of trays, the user can alternate into which side the documents are inserted thereby providing an alternating or collating function to storing documents.

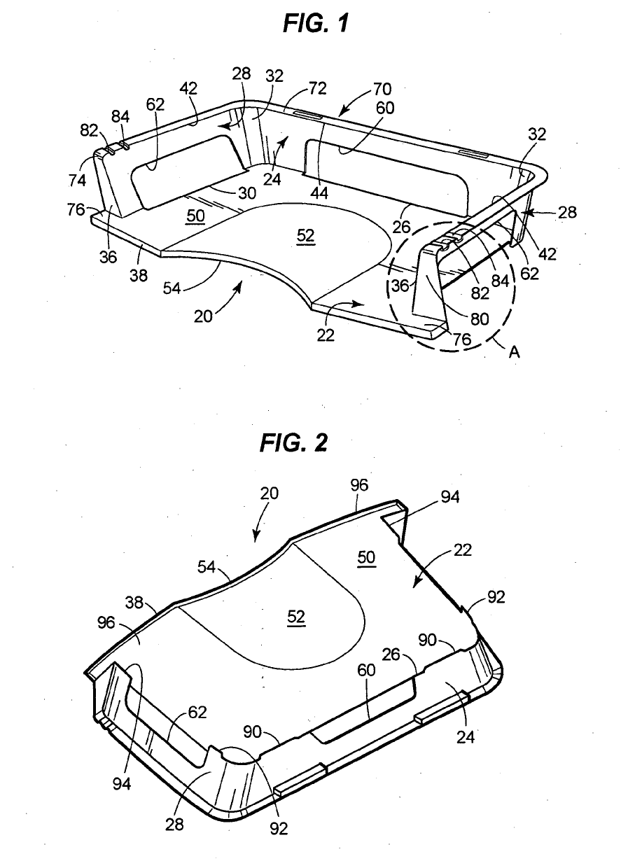

Referring now to the drawings, FIGS. 1-8B illustrate one disclosed document tray 20 constructed in accordance with the teachings of this disclosure. In this example, the document tray 20 is intended to hold letters, files, papers, and the like in a transverse, horizontal orientation wherein the long dimension of the paper is the lateral dimension inside the tray 20. As will be evident to those having ordinary skill in the art, the disclosed document or letter trays 20 can be alternatively configured to hold letters, other documents (not shown) or paper in a standard longitudinal orientation. In such a configuration, the tray 20 would have a longer depth than width. In the disclosed example, the document or letter tray 20 has a depth that is shorter than its transverse width to accommodate transversely oriented papers or documents.

In the disclosed example, the document tray 20 has a generally horizontally oriented base panel 22 and a back wall 24 with a bottom edge that is coupled to and extends generally upward from a back edge 26 of the base panel. The tray 20 also has a pair of spaced apart and opposed side walls 28 with bottom edges that are coupled to respective side edges 30 of the base panel 22. The side walls 28 extend generally forward from respective side edges or corners 32 formed at the junction between the back wall 24 and side walls 28 and extend generally upward from the side edges 30 (see FIG. 4) of the base panel 22.

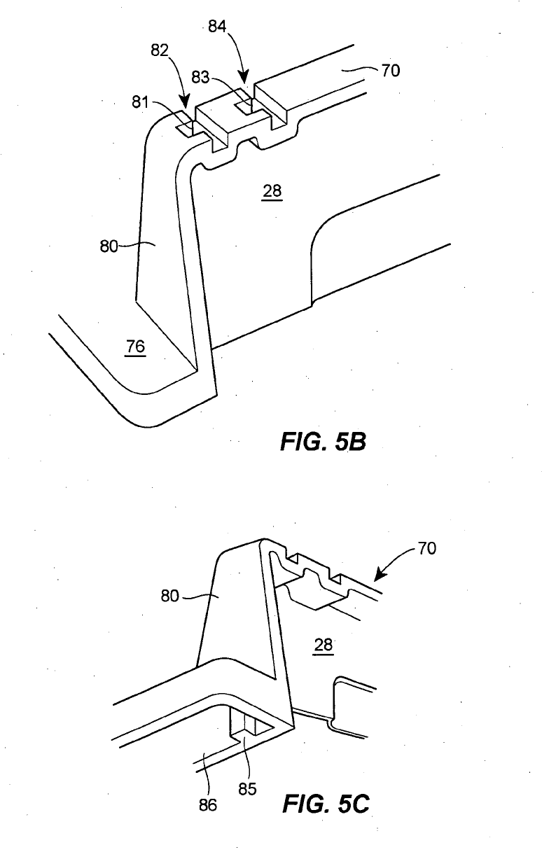

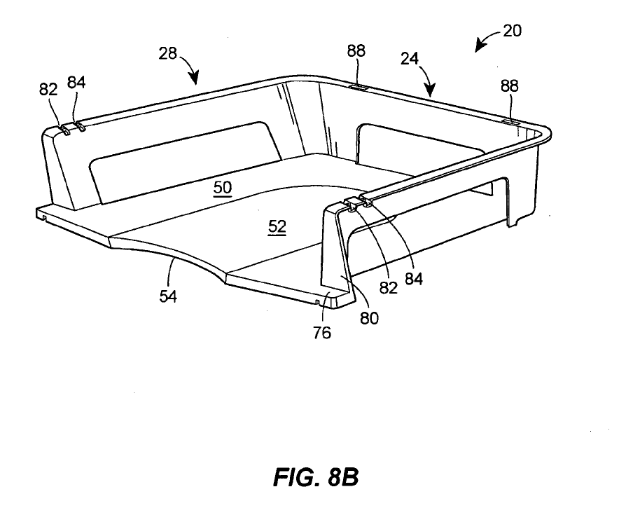

In this example, a storage receptacle or space 33 (FIG. 4) is formed within the space above the base panel 22, forward of the back wall 24, and between the side walls 28. A front opening 34 (FIG. 4) is formed between the exposed front ends 36 of the side walls 28 above a forward edge 38 of the base panel 22. The front opening permits forward insertion and removal of documents, papers, and the like in the storage receptacle space 33. A top opening 40 (FIG. 5) is defined rearward of the front opening 34, between opposed top ends 42 of the side walls 28, and forward of an upper edge 44 of the back wall 24. The top opening 40 is also available for insertion and removal of articles in the storage space 33. In this example where a single tray 20 is being used, the entire top opening 40 and front opening 38 are clear and unencumbered. However, this is not the case for some configurations where multiple trays 20 are stacked as shown below in FIGS. 7, 8A, and 8B.

Also, a portion of the top opening 40 can be covered by a short depth top wall (not shown) connected to the back wall and spanning between the side walls. A portion of the front opening can include an optional barrier or front wall (also not shown), which can extend to a height less than the height of the adjacent side walls 28. The front wall and/or the top wall can be optionally provided to assist in retaining documents within the front opening 34 and the receptacle 33 without first being grasped by a user. The front wall can also be provided as a depth of nesting stop or limiter, if desired.

FIG. 2 illustrates a bottom perspective view of the document tray 20 of FIG. 1. As shown in both FIGS. 1 and 2, the base panel 22 is a generally flat panel, though it need not be perfectly flat or planar. In the present example, a flat section 50 defines a majority of the base panel 22 in this example and extends around a perimeter of the panel adjacent the side walls 28 and back wall 24. The base panel 22 in this example also includes an optional, downwardly recessed, scooped region 52 that is centrally disposed within and surrounded on three sides by the flat section 50. In this example, the scooped region 52 extends only part way rearward toward the back wall 24, but extends all the way forward to the forward edge 36 of the base panel 22. The forward edge 36 also includes an optional scalloped area 54 that is scalloped or recessed toward the back edge 26 of the panel 22. The width of the scalloped area 54 coincides in this example with the width of the scooped or indented region 52. However, the optional scalloped area and scooped regions, if provided, can be of different width and can vary in configuration and construction from that shown in FIGS. 1, 2, and 4.

The scooped region 52 can be added to provide some structural stability and rigidity to an otherwise flat base panel 22. The scooped region 52 can also be provided to assist a user in grasping documents or other articles stored within the storage area 33. The scooped region 52 is recessed downwardly to create a small gap between an upper surface of the flat region 50 of the base panel 22 at the location of the scooped region 52 and a document or other article stored on the base panel 22. The space or gap will permit one to easily get beneath and lift the article. The scalloped area 54 can also be provided to expose a portion of an object or document in the receptacle 33 extending forward of the base panel forward edge 36 at the scalloped area 54. One can then easily grasp the exposed portion of the object.

The scooped or indented region 52 in this example extends more than half way into the depth of the base panel 22 and extends slightly less than half of the base panel 22 width. The disclosed scooped region 52 has a curved rearward end and generally straight sides extending from the curved end to the forward edge 36. However, as will be evident to those having ordinary skill in the art, the scooped region 52, if provided, can vary in configuration, size, and construction without departing from the spirit and scope of the present invention. If provided, the scooped region 52 can be of limited width so as to permit the flat section 50 of the base panel 22 to support an entire object in a flat condition, thus creating the gap at the scooped region.

The base panel 22 can also be provided with ribs or other structures, formations, or the like on both or either of the upper surface 56 or the lower surface. Such ribs or other formations can add structural rigidity and strength to the otherwise flat base panel. If raised ribs or other formations are provided on the upper surface 50 of the base panel 22, these structures can also assist in elevating documents or other articles stored in the receptacle 33 above the base panel 22. This feature can be included to create a gap between the base panel and the stored objects so that he objects can be easily grasped and lifted from the document tray 20.

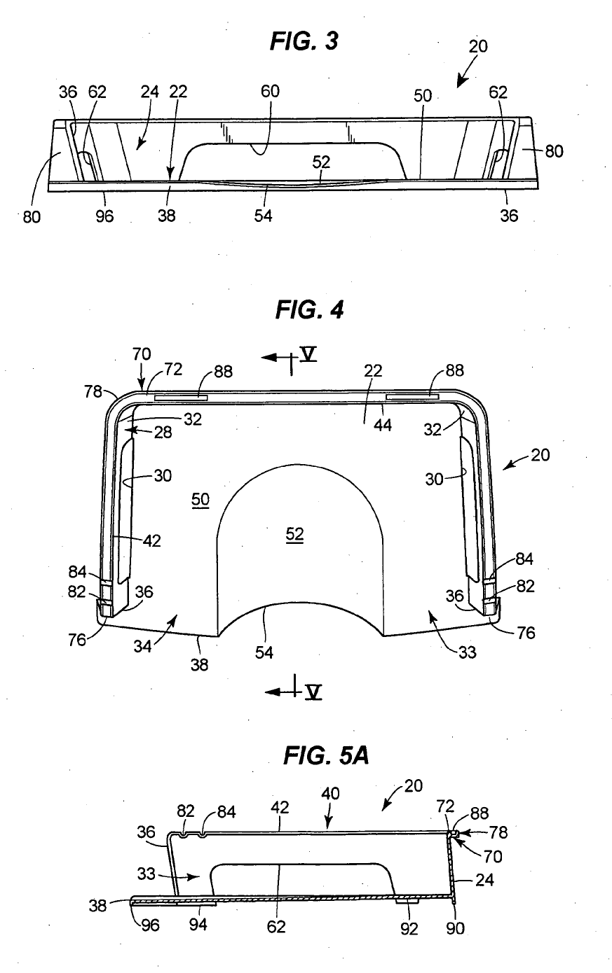

In the disclosed example of FIGS. 1-8B, the back wall 24 is shown to include an optional window or opening 60. The side walls 28 are also shown to include optional openings or windows 62. A front view of the document tray 20 is shown in FIG. 3 and best illustrates the window 60 in the back wall 24. The perspective views of FIGS. 1 and 2 illustrate the windows 62 in the side walls 28. Though each wall of the tray 20 is shown having one window 60 or 62, one or more of the walls need not have any windows or can have two or more windows as desired. The number, size, shape, and location of the windows 60, 62 can vary considerably to provide a desired function and/or aesthetic appearance, and yet fall within the spirit and scope of this disclosure.

In the example of FIGS. 1-8B, each of the windows 60 and 62 extends across a portion of a width of each respective wall 24, 28 and part way, but not completely, toward the top edges 42 of the side walls and top edge 44 of the back wall 24. However, each window 60, 62 extends all the way down to the back edge 26 of the base panel 22 and to the side edges 30 of the base panel 22 as shown in FIGS. 1-5. If desired, each window can also extend partly into the respective edge of the base panel 22 to create a scallop or inwardly recessed edge. The one or more windows 60 and 62 can be optionally provided to create a desired esthetic appearance, as noted above. However, the windows 60 and 62 can also be provided to reduce weight of the tray 20, to provide a view into the receptacle 33, to provide a handhold for carrying the tray, and/or to reduce cost per unit based on material reduction.

FIG. 4 illustrates a top view of the document tray 20 and FIG. 5 illustrates a longitudinal section through the tray 20. In the disclosed example, the side walls 28 diverge slightly away from one another in two dimensions. The side walls 28 diverge away from one another moving forward from the back wall 24 toward the front ends 36 of the side walls. The side walls 28 also diverge from one another moving upward from the base panel 22 toward the top ends 42 of the side walls. The storage area 33 thus becomes wider toward the top opening 40 (FIG. 5) and toward the front opening 34 (FIG. 4) in this example. Thus, the side walls 28 define a draft both in an upward vertical direction and in a forward horizontal direction.

As shown in FIG. 5, the back wall 24 in this example leans slightly forward relative to a vertical reference toward the forward edge 38 of the base panel 22. However, the back wall 24 can alternatively lean rearward, away from the front edge 38 of the base panel. A rim 70 extends laterally outward from the top ends 42 of the side walls 28 and rearwardly from the upper edge 44 of the back wall 24. The rim has an upward facing or upper surface 72 and in this example is a continuous rim or lip extending around the side walls 28 and back wall 24. The rim 70 can add strength and rigidity to the tray structure and can provide additional functions as described below.

The forward lean angle of the back wall 24 can be from about 1° to about 5-7° in this example, but the angle can vary. The front ends 36 of the side walls 28 can similarly lean slightly forwardly at the same angle, as in this example, also relative to a vertical reference. The forward edge 38 of the base panel 22 extends forward beyond the position of the front ends 36 of the side walls 28 at the point where they meet to provide front ledges or lateral extensions 76. In this example, the forward edge 38 extends forward beyond upper front corners 74 of the side walls as shown in the top view of FIG. 4. The lateral extensions 76 of the base panel 22 also extend laterally outward beyond the side edges 30 of the base panel 22 as best seen in FIGS. 1 and 4. These lateral extensions 76 also extend outward a distance slightly beyond the exterior perimeter edge 78 of the rim 70 at the location of the lateral extensions 76, as can be seen in FIG. 4. Structural support for the lateral extensions 76 is provided by a corresponding pair of laterally extending and vertically oriented buttresses 80 that project outward from the side walls 28 at the front ends 36 and upward from the extensions (See FIGS. 1 and 3).

In the example of FIGS. 1-8B, each side of the rim 70 has a pair of receptacles or notches 82, 84 in the upper surface 72 near the respective front comers 74 of the side walls 28. Each pair of notches 82, 84 includes a front notch 82 and a rear notch 84 recessed downwardly into the upper surface 72 of the rim 70. As can be seen in the top view of FIG. 4, the notches 82, 84 in this example are orientated at a slight angle relative to a transverse access of the tray 20. This is to accommodate stacking with other of the trays 20 as shown in FIGS. 7 and 8A.

As best seen in FIGS. 5A and 5B, the notches 82, 84 each can include a respective channel or way 81, 83 oriented generally perpendicular to the notches 82, 84 and extending forward from the respective notch. The channels 81, 83 are sized and shaped to receive a key 85 extending forward from a protrusion or rib 86 on the lower surface of the base panel 22. This configuration of the channel 81, 83 and the key 85 serves to laterally strengthen the side walls 28 when like document trays are stacked. Because the side walls diverge slightly from a vertical plane, when a like document tray is placed on top of another like document tray a torsional load is generated at the base of the side wall. The channels 81, 83 and keys 85 interlock in such a way as to effectively transfer the torsional load at the base of the side wall of the lower document tray into a tensile load along the bottom panel of the upper document tray, thereby laterally strengthening the stacked combination. Also, the channels 81, 83 in cooperation with the keys 85 will assist in retaining relative lateral alignment of stacked trays.

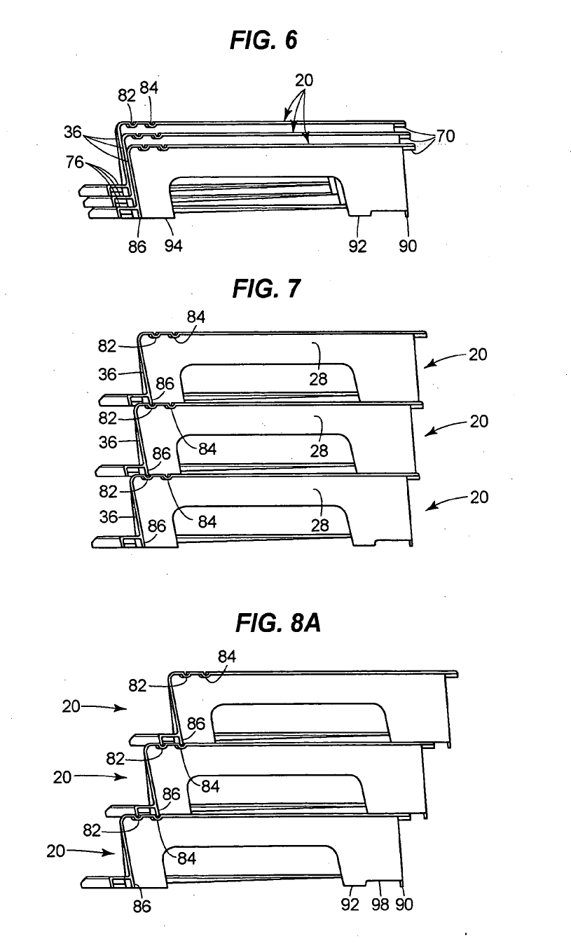

FIG. 6 shows a cross section taken longitudinally through a tray 20 and bisecting the notches 82 and 84 of one side. The ribs 86 depend downward as a continuation of each of the buttresses 80 on the sides of the tray 20. Depending upon the stacking configuration desired, as discussed below, the rib 86 is configured and oriented so that it aligns with and can be received in a selected one of the notches 82 or 84. A key 85 will then be received in the channel 81, 83 of each select notch 82 or 84.

As shown in FIGS. 4 and 5, rear notches or receptacles 88 are provided in the upper surface 72 of the rim 70. Alternatively, a single, centrally located rear notch 88 can be used. The rear notch 88 can be either blind recesses or through-openings. As seen in FIG. 5, corresponding depending rear protrusions or legs 90 extend downward from, and are a continuation of, the back wall 24 below a level of the base panel 22. The rear legs 90 are sized to be received in the rear notches 88 in one of the stacking configurations described below. As shown in FIGS. 2 and 5, additional legs are provided extending downward from the tray. These include a pair of rear legs 92 extending downward as continuations of the side walls 28 near the back wall 24 and a pair of side legs 94 extending downward as continuations of the side walls 28 near the front of the tray and positioned just behind the buttresses 80 in this example. The legs 92 and 94 are positioned adjacent the windows 60 in the side wall 28. These legs 92, 94 extend downward to the same level or height as the rear legs 90. A downwardly depending lip 96 extends from the forward edge 38 of the base panel 22 and also is of the same height as the legs 90, 92, and 94. Thus, the legs 90, 92, 94 and the lip 96 provide a stable base for the tray 22 to rest on a horizontal surface.

FIGS. 6-8A illustrate three possible stacking and/or nesting configurations that can be produced utilizing the document tray 20 shown in FIGS. 1-5. As shown in FIG. 6, the document trays 20 (in this case, three trays 20) are stacked and nested relative to one another to produce a compact, stable stack of trays 20 when not in use but when being shipped, stored, or displayed for sale. The side walls 28 and back wall 24 of one tray 20 are received and nested within the receptacle area 33 of a lower tray in this example. The buttresses 80 of one tray are positioned forward, offset upward, and adjacent the buttresses 80 of a lower tray 20 and the forward extensions 76 of the base panel 22 of one tray will rest neatly on the forward extension 76 of the lower tray 20.

The angle of the front ends 36 of the side walls 28 and the back wall 24, as well as the extension distance of the rim 70, produces the novel result of the three permissible stacks shown in FIGS. 6-8A. When multiple trays are vertically aligned, they are vertically stacked in an in-use configuration. When a plurality of trays 20 are stacked cascading or offset rearwardly, they also produce an in-use configuration with a rear cascading orientation. The rear cascading orientation permits easy access to documents or other objects stored in any given tray. If a plurality of trays 20 are stacked relative to one another and offset progressively forward, they will nest within one another as shown in FIG. 6.

The document trays 20 can be stacked on top of one another so that a space having a depth approximately the height of the side walls and back wall is defined between the stacked document trays 20 as shown in FIGS. 7 and 8A. The disclosed trays 20 can be stacked either in a generally vertical orientation (FIG. 7) or a rearwardly cascading orientation (FIG. 8A). Specific features of the disclosed document trays permit these alternative stacking and/or nesting arrangements.

As shown in FIG. 7, when a generally vertical stack of the trays 20 is desired, the rib 86 of one tray is received in the forwardmost notch 82 in the top surface 72 of the rim 70 of a second tray 20 beneath it. The angle of the forward edge 36 of the side walls 28 is such that the rib 86 and front notch 82 vertically align with one another on one tray. Thus, the vertical stack can be achieved with two or more trays 20. At the rearward end, the rear leg 90 and the rear notch 88 on a given tray 20 are also vertically aligned. Thus, the leg 90 of one tray will rest in the rear notch 88 of a lower tray when vertically stacked as shown in FIG. 7.

As shown in FIG. 8A, a cascading vertical stack can also be achieved utilizing the trays 20 disclosed herein. When stacking the trays in this configuration, the rib 86 is positioned in the notch 84 of a tray 20 beneath it. The notch 84 of one tray is rearwardly and vertically offset from the rib 86 of the same tray. Thus, when two trays 20 are stacked with the rib 86 positioned in the notch 84 of another tray, the trays 20 will be cascading, i.e., offset rearward relative to one another.

When stacked in this configuration, a bearing surface 98 positioned longitudinally rearward of the rear legs 92 bears against the upper surface 72 of the rim 70 of the lower tray 20. The legs 92 will be captured within the boundary of the side walls 28 of the lower tray as a result of the upward and outward side wall divergence. The rear leg 90 will be positioned outside the boundary of the rim 70 in this configuration.

The size and shape of the tray 20 as well as the wall 24, 28 height can vary considerably without departing from the spirit and scope of this disclosure. The configuration, shape, number, and position of the windows 60 and 62 as disclosed herein can vary considerably as well. No windows need be provided. Further, the base panel 22 can be perforated and/or include windows of its own for material reduction and/or to achieve desired characteristics.

The windows, 60, 62, if provided, can also be configured to act as handles for the document tray. A user can simply grasp a tray, whether empty of loaded, by one of the windows and place their fingers though that window making the document tray 20 easier to carry.

FIG. 8B illustrates a perspective view of an alternative embodiment of a document tray. The embodiment of FIG. 8B differs from the embodiment of FIGS. 1-8A in that the document is inserted into the storage space longitudinally instead of laterally. Therefore, the document tray is greater in depth than in width. Otherwise, the structure and elements of this embodiment are substantially the same as for the embodiment of FIGS. 1-8A and are assigned like reference numerals.

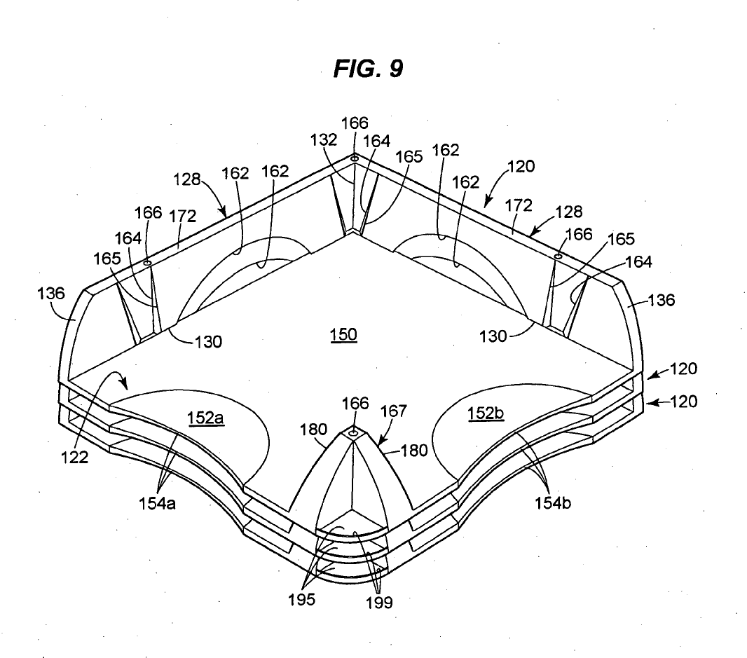

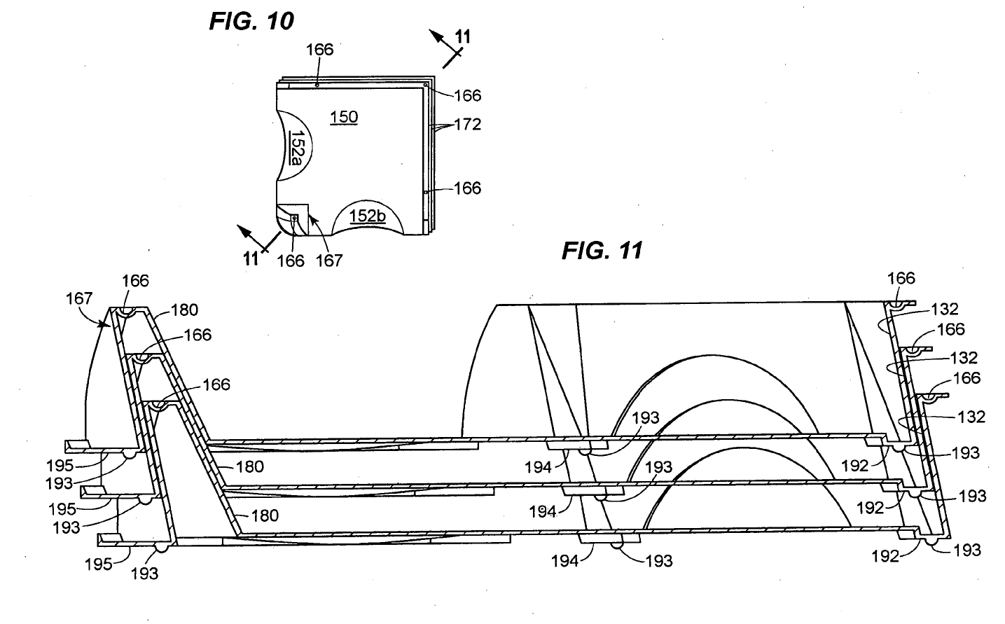

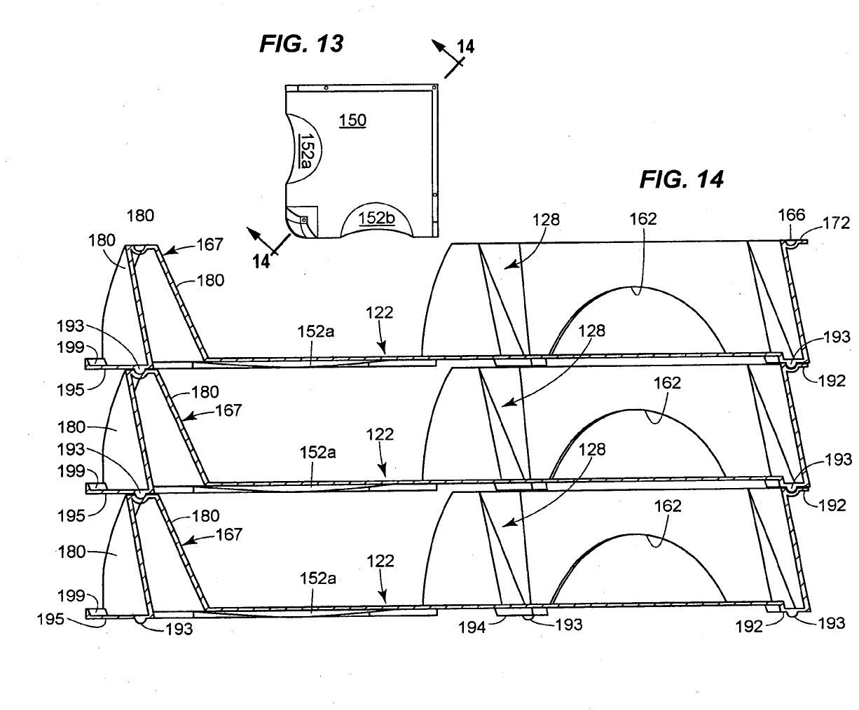

Another alternative embodiment of a document tray 120 is disclosed in FIGS. 9-14. The tray 120 has a separate collating feature in addition to the nesting and vertical stacking functions. Specifically, turning to FIG. 9, three stacked and nested trays 120 are shown. Each tray 120 has a generally horizontal base panel 122 including scooped regions 152a, 152b and a generally flat portion 150. The base panel 122 is connected to two vertical walls 128 that extend upward from the side edges shown at 130 and which form a rear corner shown at 132. Each wall 128 also includes a window 162 and a plurality of recesses shown generally at 164 that are bound by reinforcing rib structures 165. Each wall 128 terminates at an upper surface or edge 172 and has a downward extending recess or detent 166. In addition, the rear comer 132 also includes a recess or detent 166 in the upper edge 172.

A front comer post structure 167 is formed from a pair of buttresses 180 that extend upward from the base panel 122. As shown in FIG. 11, the buttresses 180 are hollow and, in the nested and stacked position shown in FIG. 11, enable the trays 120 to be neatly and tightly stacked together. The comer post 167 also includes a detent or dimple 166 in the top surface. A storage space is formed above the base panel 122 and between the side and back walls 128 and the side and front edges of the base panel 122.

As shown in FIG. 11, to place the trays 120 in the nested position, the corners 132 and hollow buttresses 180 are vertically aligned so that one tray 120 sits on top of and drops down just inside a lower tray.

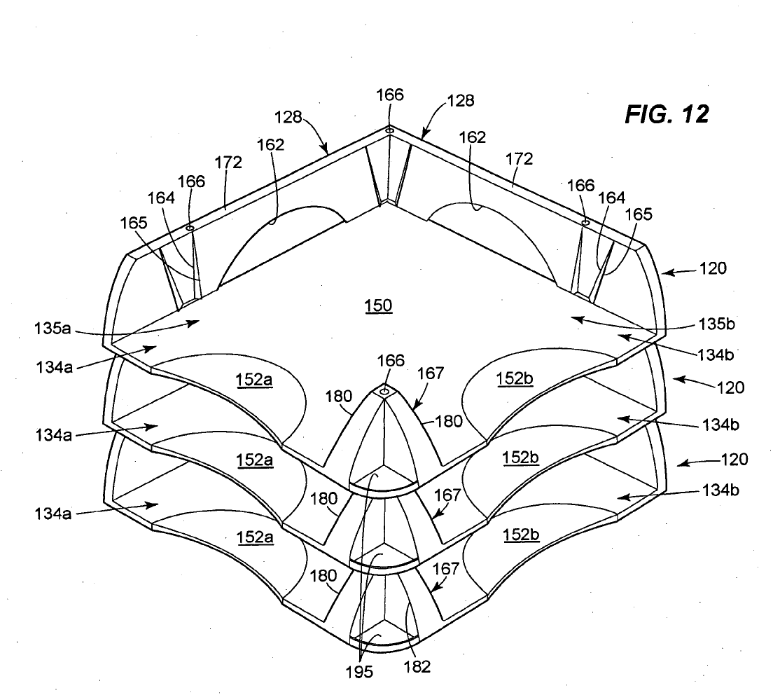

FIG. 11 also illustrates a rear foot 192 disposed beneath the comer 132 on each tray and one set of front feet 194 disposed beneath the side walls 128. In addition, another front foot 195 is disposed beneath the corner post structure 167 on each tray 120. Thus, each tray 120 has a rear foot 192, two front feet 194, and a front corner foot 195 for stability when a single tray 120 or a lower tray 120 of a stack is placed on a support surface. Each foot 192, 194, 195 has in this example a downwardly protruding boss, all of which are shown at 193. Also shown in FIG. 11 is the plurality of dimples 166 in the top edges of the comers and side walls for receiving the bosses 193 in the stacked configuration shown in FIG. 14. To place the trays 120 in the vertically stacked position shown in FIGS. 12-14, the bosses 193 of an upper tray are aligned with their respective dimples 166 of a tray beneath the upper tray, and then the upper tray is nested on the lower tray.

An additional feature of the trays 120 as shown in FIGS. 12-14 is that the corner posts 167 define two discrete front openings 134a, 134b separated by the post structures 167 which access one of two storage areas 135a and 135b. The storage areas 135a and 135b at least partially overlap near the back corner 132. Thus, a user can alternate between the openings 134a shown at the left in FIG. 12 and the openings 134b shown at the right in FIG. 12 when, for example, using the trays 120 to store different sizes of paper or different types of documents. Of course, other uses for the configuration shown in FIG. 12 are also foreseeable. The collating feature can be taken advantage of by using the front opening 134a of a first tray 120 and using the alternate opening 134b of a second tray 120 disposed either below or above the first tray 120.

As shown in FIG. 14, the bosses 193 fit neatly within the dimples 166 to provide a stable structure thereby enabling two or more trays 120 to be arranged in a given stack configuration. The comer post structure 167 with its hollow buttresses 180 also provides stability to the stacked configuration shown in FIG. 14 thereby eliminating the need for a third wall so that only the two side walls 128 need to be used with the rear corner 132. Additional stability to the structure is provided by the foot 195 and/or the wall that connects the hollow buttresses 180 of the corner post structure 167.

Similar to the tray 20 discussed above in connection with FIGS. 1-8A, the tray 120 includes scalloped areas 154a, 154b in the forward edges of the bottom panel at the pair of front openings. However, the side walls 128 include arched front ends 136 as opposed to the inwardly slanted front ends 136 and buttresses 80 as shown in FIGS. 1-6. Further, the foot or ledge 195 that extends between the buttresses 180 also includes a reinforcing upwardly protruding lip 199 for additional structural reinforcement.

Numerous modifications and alterations may be made to the design of the tray 120 shown in FIGS. 9-12. Specifically, the design of the comer post structure 167 can be modified greatly using a single post structure, a single hollow buttress 180, a single hollow column, a hollow cone, or the like. Comer structures can also be used as a substitute for the walls 128, and the windows 162 can either be enlarged or made smaller. In short, numerous design alterations can be employed to provide a stackable document tray 120 with a collating function described herein. The collating tray 120 in this example can both stack and nest, but does not cascade in a stacked configuration.

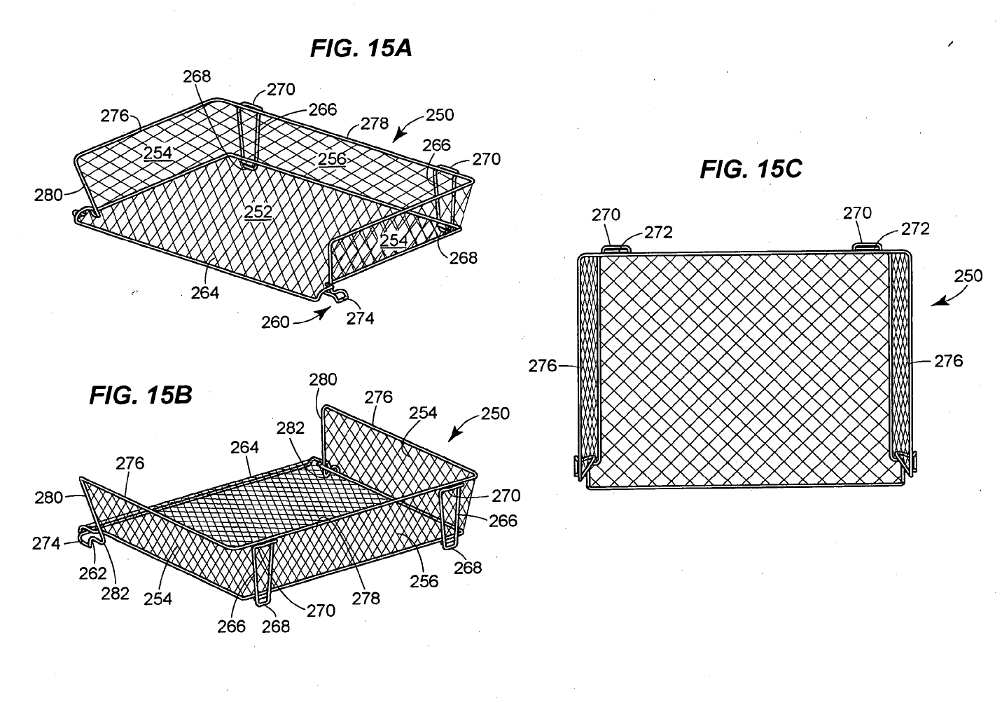

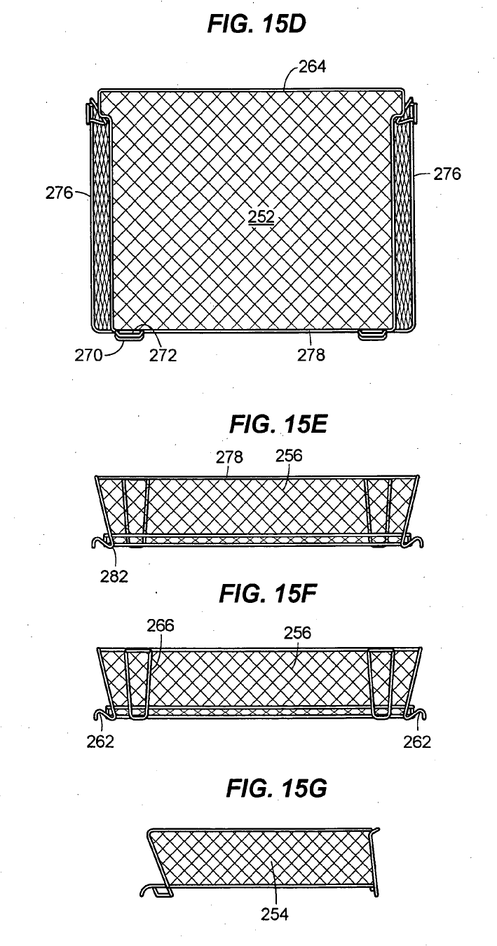

FIGS. 15A-15F depict another example of a document tray 250 constructed in accordance with the teachings of the present invention. The tray 250 is also stackable and nestable, but is also unable to cascade. In this example, the document tray 250 is constructed from wire and mesh materials and has a bottom panel 252, side walls 254, and a rear wall 256, each constructed essentially of a mesh material. A wire structure is provided to support the mesh and to give the tray rigidity and strength.

In this example, the tray 250 has a pair of laterally outwardly extending wire-form lateral extensions or ears 260 positioned near a front end of the tray 250. Each of the ears 260 has an upwardly concave curve 262. Each tray also has a downturned, curved front edge 264 of the bottom panel 252. Each tray 250 further has a pair of spaced apart wire-form structures 266 attached to the rear wall 256 in laterally spaced apart relation. The bottom of each structure 266 extends below the bottom panel, forming a pair of depending wire loop rear feet 268. The tops of the structures bend outward and spaced away from the rear wall 256 to form a pair of rearwardly protruding wire loops 270. Each loop 270 creates an aperture 272 carried near the upper end of the rear wall. Each distal end of the front ears 260 terminates at a downturned front foot 274 that extends below the bottom panel 252 about the same distance as the rear feet 268. When in use, the tray 250 can rest on the feet 268, 274 on a support surface.

The wire support structure of the tray 250 includes a pair of side wall top wires 276, one running along each side wall 254. A rear wall top wire 278 runs along the top edge of the rear wall 256. The loops 270 and apertures 272 are spaced outward of the rear wall top wire 278. As in prior examples, the side walls 254 taper outward away from one another and the rear wall is tilted slightly inward. However, the rear wall need not be tapered or tilted inward but instead can alternatively be vertical or taper outward if desired. Further, in this example, the side walls do not diverge away from one another moving toward the front of the tray. Instead, the side walls are the same distance apart from the back wall to the tray front.

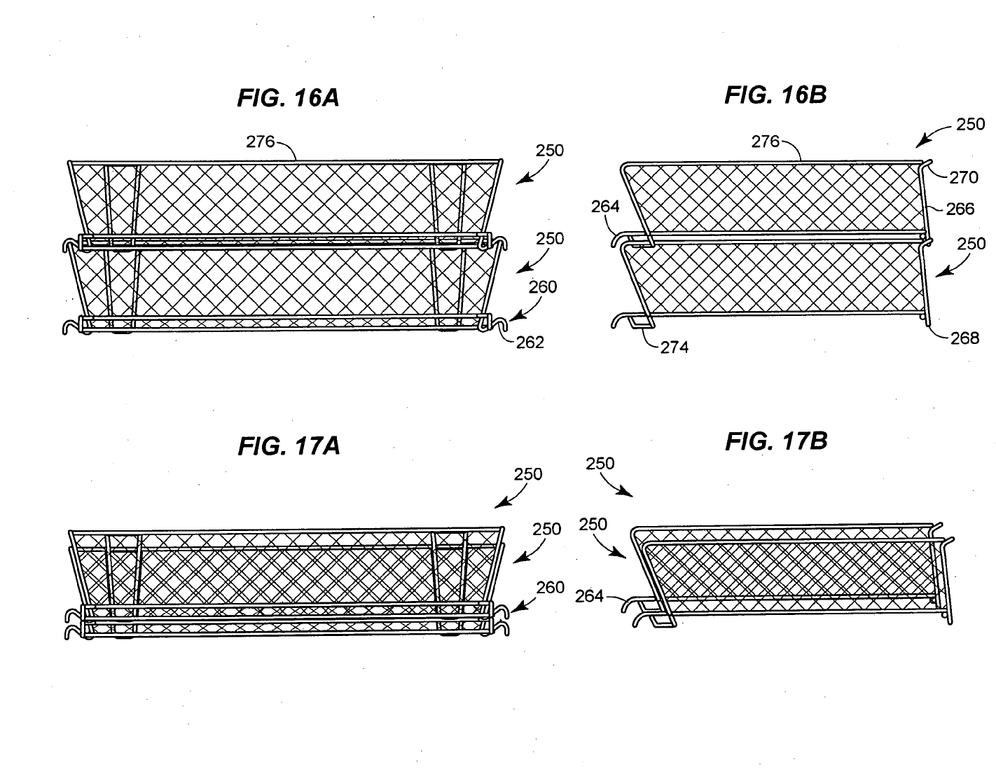

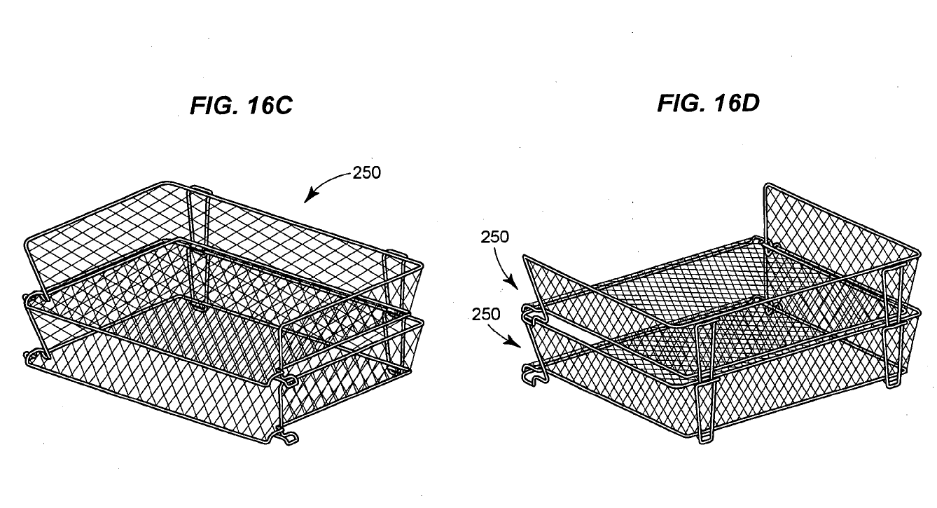

Turning to FIGS. 16A-16D, the tray 250 can be vertically stacked with one or more like trays 250. The concave curve 262 of each of the front feet 274 of an upper tray 250 receives and rests on the top wire 276 of one of the side walls 254 of a lower tray 250. The rear feet 268 of the upper tray drop into corresponding ones of the apertures 272 of the loops 270 in the wire structures 266 on the rear wall of the lower tray. In this configuration, the trays 250 can be vertically stacked for use.

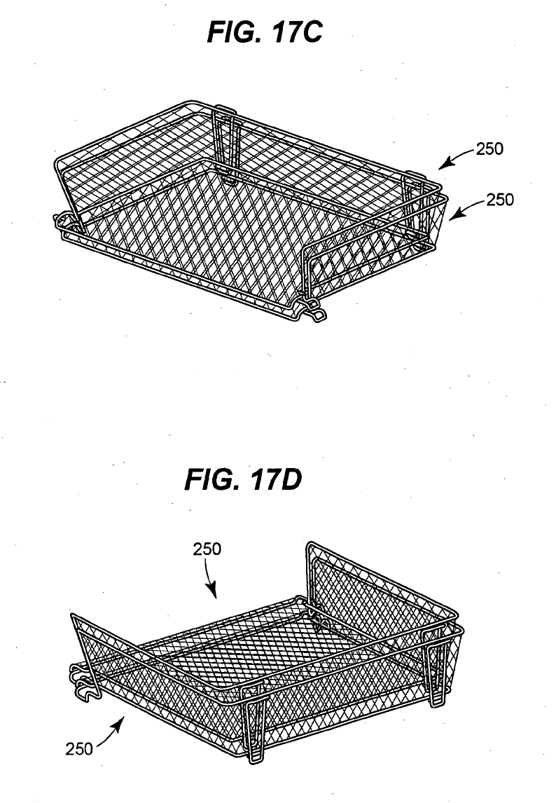

As shown in FIGS. 17A-17D, the tray 250 can be stacked and nested with one or more like trays 250. The ears 260 of the upper tray can be positioned forward of the respective front edges 280 of the lower tray to nest on the bottom panel of the lower tray. The rear feet 268 of the upper tray rest on the bottom panel 252 of the lower tray. Each of the wire-form ears can have a bend forming a rest 282 that extends downward to about the same distance as the rear feet 268. The rest 282 on each ear of the upper tray rests on the bottom panel 252 of the lower tray. Thus, the rests 282 and rear feet 268 can be sized to prevent side and back walls of the nested trays from frictionally engaging with one another when stacked and nested. A consumer can easily remove one of the nested trays 250 and replace it if desired with little effort. The front edge 264 can be curved downward to render it easy to grasp the tray 250 and also to present documents stored therein for easy retrieval.

The ears 260 need not be wire-form. Instead, the ears can be bent, curved, solid tabs extending outward from the sides of the tray. Also, the structures 266 on the rear wall of the tray 250 need not be wire form. The structures can also be solid, flat strips of material, bent to form an upper receptacle to receive therein the rear feet of a tray stacked on top of the tray.

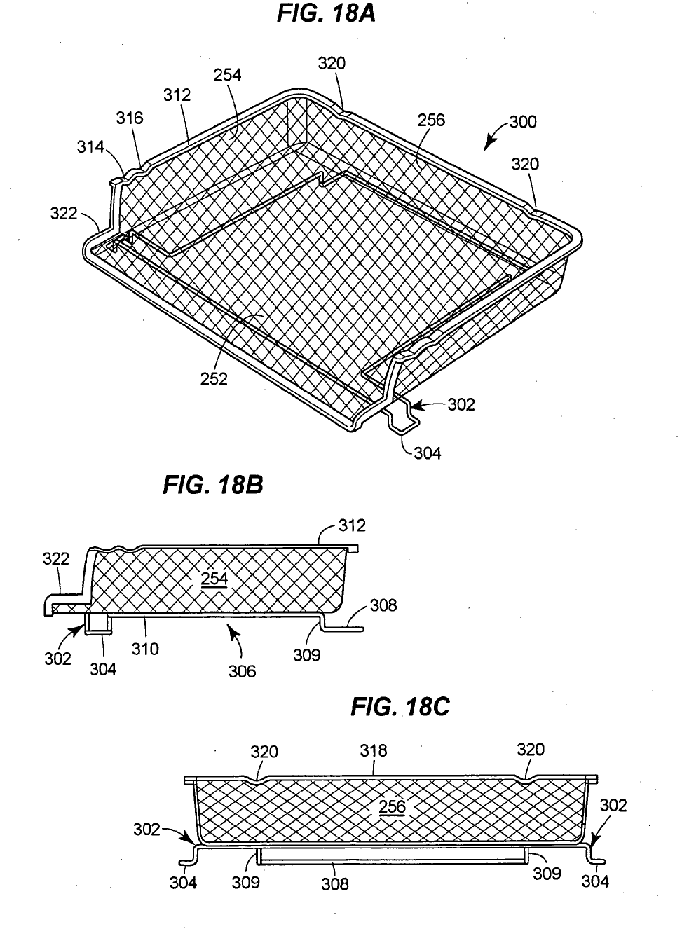

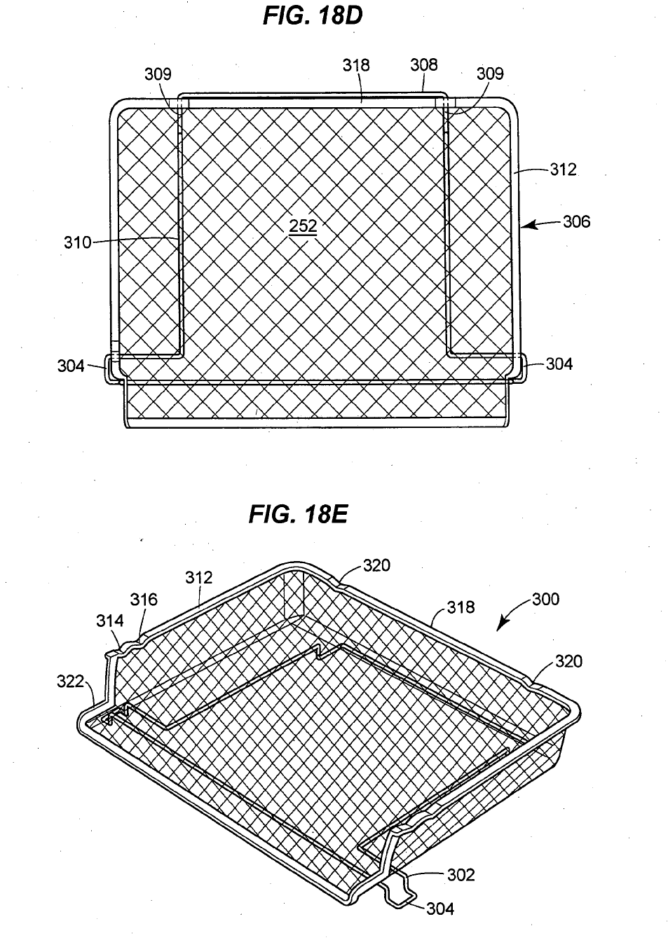

Turning to FIGS. 18A-18E, a document tray 300 is shown that is similar to the tray 250 in that it is a wire and mesh construction. The wire configuration is altered in this example and given new reference numbers. The mesh walls are essentially the same and, thus, are given like reference numbers. In this example, the document tray 300 is constructed from wire and mesh material and has a bottom panel 252, side walls 254, and a rear wall 256, each constructed essentially of mesh material. A flat wire structure is provided to support the mesh and to give the tray rigidity and strength.

In this example, the tray 300 has a pair of outwardly extending wire-form lateral extensions or ears 302. Each of the ears 302 has a stepped configuration terminating at a horizontal front foot portion 304. The front foot portion 304 extends below the bottom panel 252. The tray 300 also has a bottom wire loop 306 that extends around the bottom of the tray generally within the perimeter of the bottom panel 252. The wire loop 306 forms the feet 304 and ears 302. A rear bar 308 of the wire is stepped downward at stepped portions 309 from side bars 310 of the wire loop. The stepped portions 309 extend rearwardly and the rear bar 308 extends laterally across the tray 300. The rear bar 308 is spaced outwardly a distance from a plane of the rear wall 256. The rear bar 308 is positioned a distance below the bottom panel 252 about the same distance as the front foot portions 304. During use, the tray 300 can rest on the rear bar 308, stepped portions 310, and foot portions 304 on a surface.

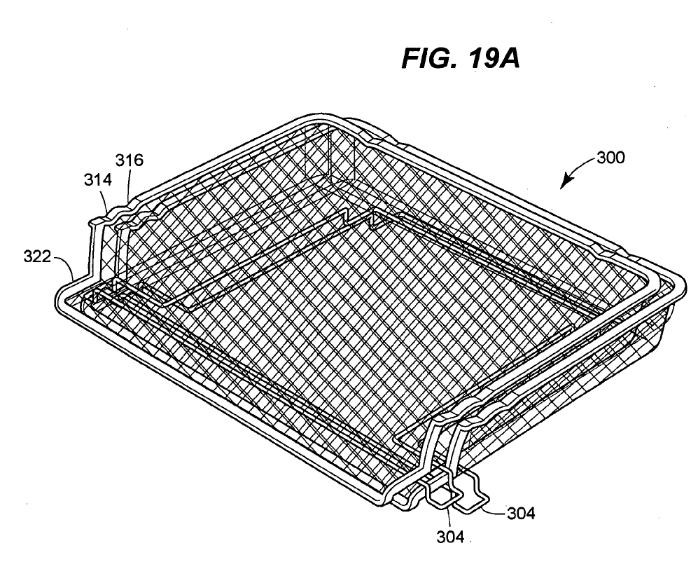

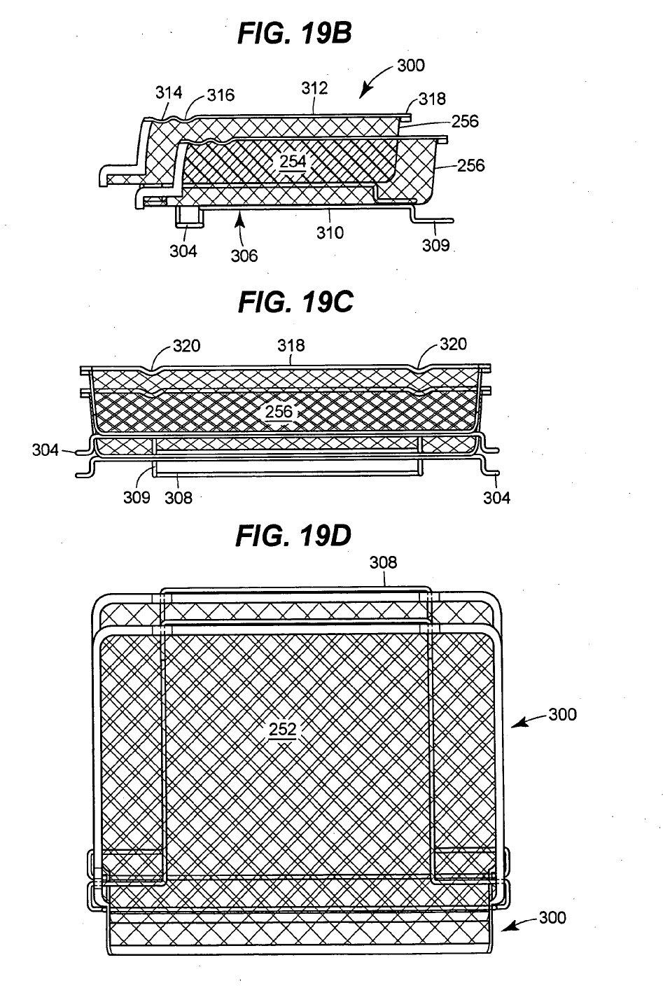

The top wire 312 of each side wall 254 has a pair of front depressions 314 and 316 formed therein near the front edge 314 of each side wall. The first depression 314 is spaced forward of the second depression 316. The top wire 318 of the rear wall 256 also has a pair of spaced apart depressions 320 formed therein and spaced apart along the top wire. As can be seen in FIGS. 19A-D, when two or more trays 300 are stacked and nested, the foot portions 304 of an upper tray sit forward of the front edge of the side walls 254 of a lower tray and rest on side supports 322 that rise from edges of the bottom panel 256 forward of the side walls 254. The rear bar 308 rests on the bottom panel 252 of the tray 300 as shown in FIG. 19B.

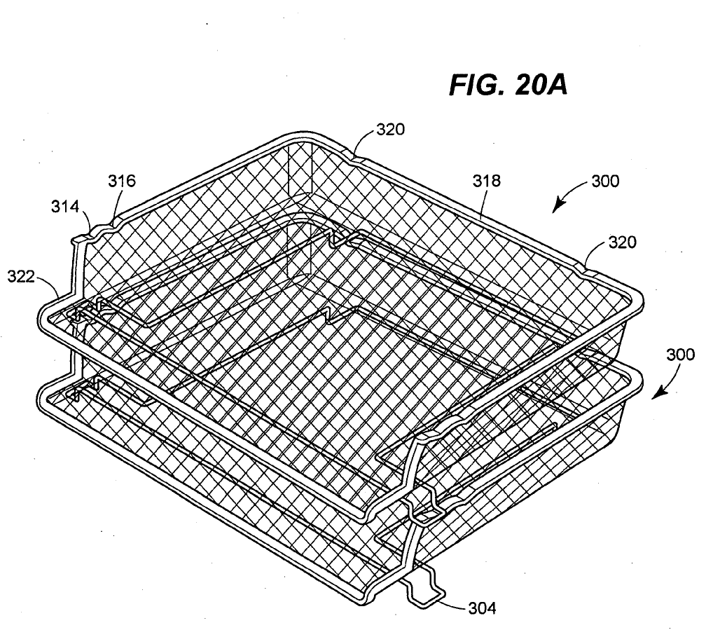

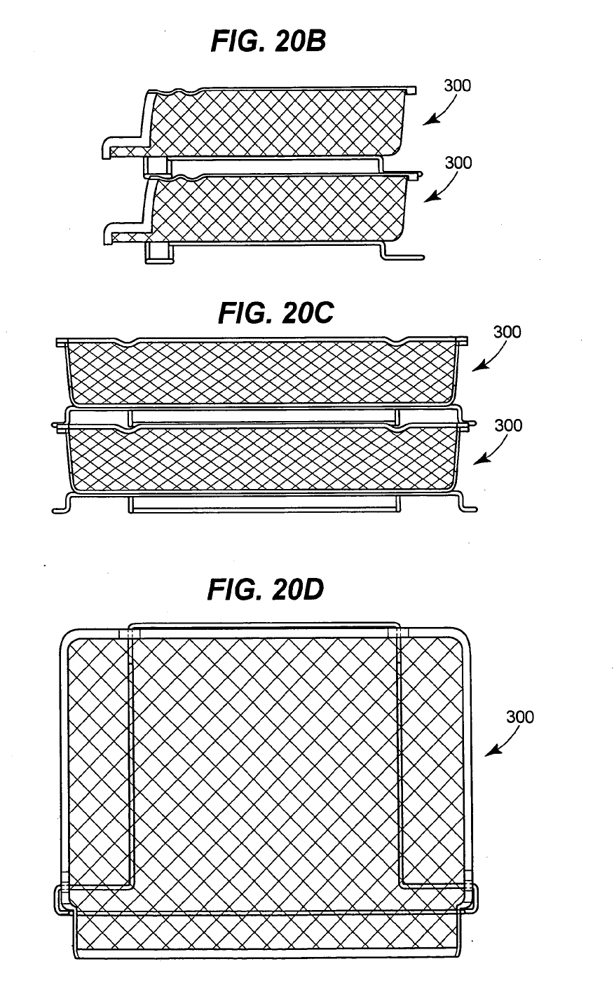

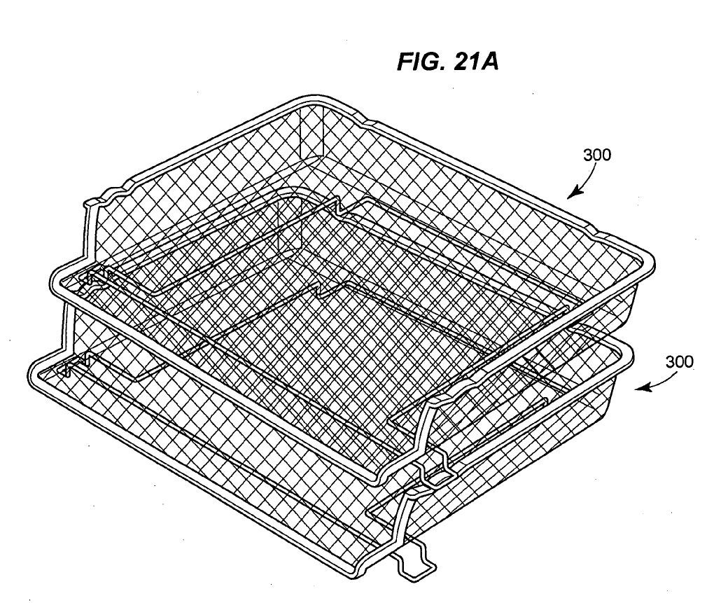

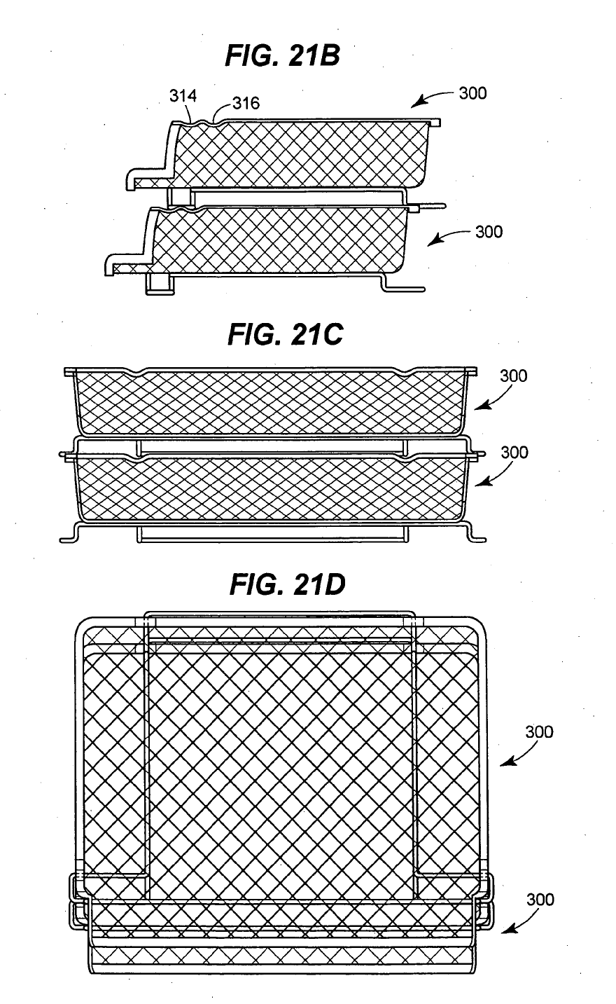

As shown in FIGS. 20A-20D, when two or more of the trays 300 are vertically stacked, one of the pair of spaced apart wires forming the foot portion 304 rests in the first depression 314 in each side wall top wire. The wires of the stepped portions 310 rest in a respective one of the rear depressions 320 as shown in FIGS. 20C and 20D. As shown in FIGS. 21A-21D, when two or more of the trays are stacked and cascaded, one of the pair of spaced apart wires of each of the foot portions 304 rests in a respective one of the front and rear depressions 314 and 316 in each side wall top wire. The elongate wires of the stepped portions 310 simply shift rearward in relation to the rear depressions 320, but rest therein.

As will be evident to those having ordinary skill in the art, the wire and mesh configurations shown herein are merely examples of many variations and modifications that can be made to the document trays disclosed herein. In one example, the trays can stack and nest. In another example, the trays can stack, nest, and cascade. In a further example, the trays can stack, nest, and offer collated storage. The means to accomplish such tray features can vary considerably and yet fall within the spirit and scope of the invention. The rear walls can have one, two, or three or more notches, loops, or other features to facilitate stacking. The side walls can have a wide variety of notches, depressions, or the like to also facilitate stacking and cascading, as desired. The rolled mesh front edge can be added to provide rigidity as well to the structure.

Merchandisers and retailers of horizontal orientation document or letter trays typically provide shelf space and arrangements that vary from store to store and from retailer to retailer. Thus, a product configuration that is suitable for display in a shelf space at one store or retailer may not be suitable for a shelf space or configuration at another retailer or store. The disclosed document trays permit stacking and nesting of a large number of the products. The disclosed document trays can thus be displayed, packaged, shipped, stocked, stored, and the like within a relatively small amount of shelf space.

By maximizing packaging and shipping space as well as store shelf space by utilizing the disclosed tray configurations, one is able to ship and store a larger product volume per unit area. This creates more space within an existing product display in a limited shelf storage space that may have been originally suited for a completely different product. This can increase revenue dollars for the retailer per square foot of shelf space. The tight nesting products may also permit adding the disclosed document trays to an existing store shelf space without having to knock out another product from that same shelf space.

Document trays for storing items such as files, papers, letters, or the like in a horizontal orientation have not heretofore been designed having the nesting, stacking, and optional cascading and collating characteristics disclosed herein. Some solutions have been provided, but these typically require that the trays offered for sale be separately packaged or packaged only in pairs. Such products typically are packaged to protect the articles from being damaged by one another while being shipped or while on display for sale. Because a typical tray of this type does not tightly nest with like trays, the trays can become scuffed, scratched, or the like as they move and bang into one another.

In contrast, the disclosed tray configurations may eliminate the need for utilizing foam, paper, corrugated elements, poly bags, or other such packing materials. Instead, the disclosed document trays can be shipped, stored, and displayed in tightly nested stacks. The stacks will provide stability to the shipped, stored, and displayed products. The products can stand alone without additional packing both in shipping containers and on a retailer's shelf storage space.

Some other existing office products of the type described herein are capable of nesting, unlike that disclosed here and with only one other like product. The two products must be inverted or turned upside down and rotated 180 degrees relative to one another in order to nest. If nestable, existing document trays are not known to offer the stacking options of the trays disclosed here. These known tray products also must still utilize additional packaging to prevent the products from moving relative to one another, which would otherwise cause scuffing or scratching. Such known products do not typically optimize product nesting and reduce shelf space to the degree accomplished by the disclosed document trays.

The disclosed document trays substantially reduce the necessary space required for shipping, storage, and retail sale, yet maintain the standard function for document tray products. The standard function is typically known to be that of horizontally storing letters, document, papers, files, folders, magazines, and other like sized objects. The disclosed trays can nest with one another while still meeting the aforementioned function and minimizing the possibility of product damaged during shipping.

The materials and processes used to manufacture the disclosed trays can vary considerably and yet fall within the spirit and scope of the present invention. However, in one example, the document trays disclosed herein can be manufactured using an injection molding process. The materials utilized in one example can be commodity plastics such as polystyrene or polypropylene. However, many other materials may be suitable for forming the disclosed tray configurations. For example, other materials may include engineering grade plastic materials such as polycarbonate, ABS or TPE. Other commodity thermoplastics, or even further alternative materials such as metal, wood, organic materials, leather, glass, or variations and combinations of these materials, as well as other secondary fabrics and woven materials. Material selection may assist in creating a higher impact strength, flexibility, improved resistance to scratching or scuffing, or enhanced appearance. The material selection can be undertaken with important characteristics in mind for a given application. However, engineering plastics such as polystyrene or polypropylene also lend themselves to reduce consumer cost.

The disclosed document trays can be painted, decorated, or in-molded with labels, graphics, or other layers or accents. These additional design characteristics can be employed to protect the surfaces of the document tray or to enhance the decorative nature of the product. Combinations of materials can be utilized and assembled in any suitable way, including forming a plastic underbody product with rubber over-molded on the plastic base material. Alternatively, metal parts can be mechanically fastened together or wood products can be covered with suitable decorative materials such as fabric, metal decorative and protective corner features, and the like.

Depending upon the materials selected, the manufacturing processes and methods used can also vary and be employed as needed. In one example, a plastic document tray disclosed herein can be molded using a simple two part mold. The draft angle of the side walls 28, 128, front edges 36, 136, and back wall 24 provide the necessary mold draft for easy formation and removal of parts from the mold cavities. The windows 60, 62, 162 in the walls 24, 28, 128 can be formed by providing shut-offs or surface to surface metal contact within the mold. By extending the windows 60, 62, 162 into both the side and back walls 24, 28, 128 and at least slightly into the bottom panel 22, 122, the shut-off can be provided and yet permit easy mold separation and part removal. The disclosed document tray configurations should be molded with mold separation occurring at an angle relative to a reference that is perpendicular to the base panel. This is because the back wall 24, 124 leans at an angle slightly inward toward the storage receptacle 33, 133. The mold separation direction should be such that the back wall 24, 124 is tilted at a slight draft angle away from the mold separation axis or direction.

The disclosed trays improve upon maximizing retail shelf space, accommodate variable shelf space and configurations, and enhance product nesting shipping, stock storage, and display for sale. Product nesting is accomplished in a slightly bi-directional manner whereby each tray is stacked vertically upward and offset slightly horizontally forward relative to its preceding tray in a stack. The stacked trays can be displayed and shipped without damage to the product due to scuffing, scrapping, and the like because the products will be tightly nested. Additional packing can be negated. A number of the disclosed trays can also accommodate two alternative in-use stack orientations. These trays can be stacked in either a vertical in-use configuration or in a rearward cascading in-use configuration.

Additionally, freight cube size can be optimized and significantly reduce utilizing the disclosed nested document tray configuration. Products shipped in bulk can be directly unloaded from the master carton or shipping box onto a shelf. No additional reorientation of the product may be necessary, making the merchandiser's handling of the product easier. The nested trays also assist in retaining the displayed trays on a retail shelf space. The trays also look more organized when nested as disclosed herein. This reduces the amount of work required by the customer/merchandiser to keep the shelf display organized and arranged. An organized shelf space may effect the perception of the consumer and influence his or her decision to buy the displayed products.

Further, because more product can be displayed for sale in a given amount of shelf space, less restocking time and stocking space is necessary for the retailer. Having more product available for sale at any one time reduces the frequency of an item appearing to be out of stock, which can prevent a consumer from leaving the establishment to go elsewhere to find the desired product.

Although certain document trays that are nestable and stackable have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A document tray comprising:
a base panel having a rear edge, a forward edge, a pair of opposed side edges and an upper and lower surface;
a rear wall extending upward near the back edge of the base panel and having a lower edge, an upper edge, and a pair of side edges;
a pair of side walls spaced apart and opposed relative to one another, one each extending generally upward relative to a respective one of the side edges of the base panel;
a rim which extends laterally outward from top edges of the side walls forming a lip on the top edges of the side walls and the upper edge of the rear wall; and
a means for laterally strengthening the pair of side walls by transferring a torsional load at the base of each of the side walls to a tensile load across the bottom panel of a second document tray.

2. The document tray of claim 1, wherein the means for means for laterally strengthening the pair of side walls comprises at least one notch in the rim and at least one rib on the lower surface of the base panel of the like document tray, and wherein the at least one notch in the rim is adapted to receive a portion of the at least one rib when the document trays are stacked with one another.

3. The document tray of claim 2, wherein the notch has a forward facing channel configured to receive a portion of a key disposed on the at least one rib when the document trays are stacked with one another.

4. The document tray of claim 3, wherein the forward facing channel is substantially perpendicular to the notch.

5. The document tray of claim 1, wherein the means for means for laterally strengthening the pair of side walls comprises at least two notches.

6. The document tray of claim 5, wherein the means for laterally strengthening the pair of side walls comprises at least two ribs.

7. The document tray of claim 5, wherein the means for means for laterally strengthening the pair of side walls comprises at least four notches.

8. The document tray of claim 1, wherein the means for laterally strengthening the pair of side walls comprises a slit in the front edge of the base panel, the slit being configured to receive a raised portion within the notch of another document tray.

9. The document tray of claim 8, wherein the means for laterally strengthening the pair of side walls comprises at least two slits in the front edge of the base panel.

10. The document tray of claim 9, wherein the means for laterally strengthening the pair of side walls comprises at least two notches.

11. The document tray of claim 10, wherein the means for laterally strengthening the pair of side walls comprises at least four notches.

12. The document tray of claim 1, wherein the means for laterally strengthening the pair of side walls comprises at least one upwardly concave lateral extension formed near the forward edge of the base panel, the at least one lateral extension configured to receive a portion of the top edge of a side wall of another document tray when two or more document trays are stacked with one another.

13. A plurality of stackable and nestable document trays each comprising:
a base panel having a rear edge, a forward edge, a pair of opposed side edges and an upper and lower surface;
a rear wall extending upward near the back edge of the base panel and having a lower edge, an upper edge, and a pair of side edges;
a pair of side walls spaced apart and opposed relative to one another, one each extending generally upward relative to a respective one of the side edges of the base panel;
a rim which extends laterally outward from top edges of the side walls forming a lip on the top edges of the side walls; and
a means for laterally strengthening the pair of side walls by transferring a torsional load at the base of each of the side walls to a tensile load across the bottom panel of a second document tray,
wherein each of the document trays in the plurality of document trays is stackable with other document trays in the plurality of document trays in both a stacked nested configuration and a stacked in-use configuration.

14. The plurality of trays of claim 13, wherein in the stacked in-use configuration, the trays may be arranged directly above one another or in a cascading configuration in which one of the trays is offset rearwardly from an adjacent one of the trays.
